(19) United States
(12) Patent Application Publication
(10) Pub. No.: US 2021/0316631 A1
(43) Pub. Date: Oct. 14, 2021

(54) Systems and Methods for Charging Electric Vehicles

(71) Applicant: Revitalize Charging Solutions, Inc., Fort Worth, TX (US)

(72) Inventor: Edward Morgan, Fort Worth, TX (US)

(21) Appl. No.: 16/845,015

(22) Filed: Apr. 9, 2020

(51) Int. Cl. B60L 53/63; B60L 53/62; B60L 58/12

(52) U.S. Cl. CPC B60L 53/63; B60L 58/12; B60L 53/62

(57) ABSTRACT

In certain embodiments, a charging system comprises distribution circuitry, power connectors, and a computer. The distribution circuitry provides power from a power supply. Each power connector couples the distribution circuitry to an electric vehicle of a set of electric vehicles and transmits current to the electric vehicle. The computer: receives a charging request from each electric vehicle; determines an allocation of power according to the charging requests; and instructs the distribution circuitry to send current to the electric vehicles according to the allocation of power. The computer adjusts the allocation of power to the electric vehicles by: detecting a change in the actual amount of current drawn by a particular electric vehicle; adjusting the allocation of power to the electric vehicles according to the change; and instructing the distribution circuitry to send the current to the electric vehicles, including the particular electric vehicle, according to the adjusted allocation of power.

### TECHNICAL FIELD

The present disclosure relates generally to charging batteries, and more particularly to systems and methods for charging electric vehicles.

### BACKGROUND

A battery has electrochemical cells that store electric charge and generate direct current (DC) through the conversion of chemical energy into electrical energy. A battery can be charged by feeding an electric current through the battery such that the cells hold on to the energy passing through them.

Many different things are powered by rechargeable batteries. For example, mobile devices, tools, appliances, and even cars are now powered by rechargeable batteries. Charging one battery at a time is time-consuming, so a charging system that can charge multiple batteries provides more efficient charging.

### BRIEF SUMMARY

In certain embodiments, a charging system comprises distribution circuitry, power connectors, and a computer. The distribution circuitry provides power from a power supply up to a maximum output. Each power connector couples the distribution circuitry to an electric vehicle of a plurality of electric vehicles, each electric vehicle having a battery, and transmits current from the distribution circuitry to the electric vehicle. The computer: receives a charging request from each electric vehicle, the charging request from an electric vehicle requesting an amount of power for a battery of the electric vehicle; determines an allocation of power according to the charging requests, the allocation of power specifying an amount of power to be allocated to each electric vehicle; and instructs the distribution circuitry to send current to the electric vehicles according to the allocation of power. The computer adjusts the allocation of power to the electric vehicles by: monitoring an actual amount of current drawn by each electric vehicle; detecting a change in the actual amount of current drawn by a particular electric vehicle; adjusting the allocation of power to the electric vehicles in response to the change; and instructing the distribution circuitry to send the current to the electric vehicles, including the particular electric vehicle, according to the adjusted allocation of power.

Examples of these embodiments may include none, one, some, or all of the following features:
The computer may be configured to determine the allocation of power according to the charging requests by: determining that the sum of the requested amounts of power of the charging requests is less than the maximum output; and defining the allocation of power to allocate the requested amounts of power to the electric vehicles.
The computer may be configured to determine the allocation of power according to the charging requests by: determining that the sum of the requested amounts of power of the charging requests is greater than the maximum output; and defining the allocation of power to allocate to at least one electric vehicle less power than was requested in its charging request.
The computer may be configured to define the allocation of power to allocate to at least one electric vehicle less power than was requested by: allocating power to the electric vehicle with the lowest requested amount of power; repeating the following from a lower amount of requested power to the next higher amount of requested power until the maximum output is distributed: if there is remaining power, allocating the remaining power to the electric vehicle with the next higher requested amount of power.
The computer may be configured to define the allocation of power to allocate to at least one electric vehicle less power than was requested by: allocating more power to an electric vehicle with a higher requested amount of power than to an electric vehicle with a lower requested amount of power.
The computer may be configured to define the allocation of power to allocate to at least one electric vehicle less power than was requested by: allocating the power to the electric vehicles according to their proportion of their requested power.
The computer may be configured to define the allocation of power to allocate to at least one electric vehicle less power than was requested by: allocating the power substantially equally among the electric vehicles.
The computer may be configured to define the allocation of power to allocate to at least one electric vehicle less power than was requested by: determining a state of charge for the battery of each electric vehicle; and allocating power according to the states of charge of the batteries.
The computer may be configured to define the allocation of power to allocate to at least one electric vehicle less power than was requested by: determining a priority assigned to each of the electric vehicles; and allocating more power to an electric vehicle with a higher priority than to an electric vehicle with a lower priority.
The computer may be configured to define the allocation of power to allocate to at least one electric vehicle less power than was requested by: determining a priority assigned to each of the electric vehicles; and allocating power to the electric vehicle with the highest priority; repeating the following from a higher priority to the next lower priority until the maximum output is distributed: if there is remaining power, allocating the remaining power to the electric vehicle with the next lower priority.
The computer may be configured to adjust the allocation of power to the electric vehicles by: determining that the actual amount of current drawn by the particular electric vehicle has decreased to yield an available amount of power; identifying a set of one or more of the other electric vehicles that are receiving less than their requested power; and increasing the power allocated to the set of electric vehicles by the available amount.
The computer may be configured to increase the power allocated to the set of electric vehicles by the available amount by: allocating the available amount substantially equally among the set of electric vehicles.
The computer may be configured to increase the power allocated to the set of electric vehicles by the available amount by: allocating the available amount to the set of electric vehicles according to their proportion of their requested power.
The computer may be configured to increase the power allocated to the set of electric vehicles by the available amount by: allocating more of the available amount to an electric vehicle of the set with a lower requested power than to an electric vehicle of the set with a higher requested power.
The computer may be configured to increase the power allocated to the set of electric vehicles by the available amount by: allocating more of the available amount to an electric vehicle of the set with a higher requested power than to an electric vehicle of the set with a lower requested power.
The computer may be configured to increase the power allocated to the set of electric vehicles by the available amount by: determining a priority assigned to each electric vehicle of the set; and allocating more of the available amount to an electric vehicle of the set with a higher priority than to an electric vehicle of the set with a lower priority.
The computer may be configured to increase the power allocated to the set of electric vehicles by the available amount by: determining a priority assigned to each electric vehicle of the set; and allocating at least some of the available amount to the electric vehicle with the highest priority to reach the requested amount of power for the electric vehicle; repeating the following from a higher priority to the next lower priority until the available amount is distributed or until the requested amounts of power for the set of electric vehicles have been reached: if there is remaining power, allocating the remaining power to the electric vehicle with the next lower priority to reach the requested amount of power for the electric vehicle.

In other embodiments, a charging system comprises distribution circuitry, power connectors, and a computer. The distribution circuitry provides power from a power supply up to a maximum output. Each power connector couples the distribution circuitry to an electric vehicle of a plurality of electric vehicles, each electric vehicle having a battery, and transmits current from the distribution circuitry to the electric vehicle. The computer receives a charging request from each electric vehicle, the charging request from an electric vehicle requesting an amount of power for the battery of the electric vehicle; sets an allocation of power to allocate the maximum output substantially equally among the set of electric vehicles; and instructs the distribution circuitry to send current to the electric vehicles according to the allocation of power. The computer adjusts the allocation of power to the electric vehicles by: monitoring an actual amount of current drawn by each electric vehicle; determining that the actual amount of current drawn by a particular electric vehicle is less than the amount corresponding to the power allocated to the particular electric vehicle, yielding an available amount of power; adjusting the allocation of power to give the available amount of power to one or more of the other electric vehicles; and instructing the distribution circuitry to send the current to the electric vehicles, including the particular electric vehicle, according to the adjusted allocation of power.

Examples of these embodiments may include none, one, some, or all of the following features:
The computer may be configured to adjust the allocation of power to the electric vehicles by: determining that the adjusted allocation of power provides less than the maximum output to the electric vehicles; and setting the adjusted allocation of power to allocate the maximum output substantially equally among the electric vehicles.

In certain embodiments, a charging system comprises distribution circuitry, power connectors, a current monitor, and a computer. The distribution circuitry provides power from a power source up to a maximum output. Each power connector comprises a port configured to: couple the distribution circuitry to an electric vehicle of a plurality of electric vehicles, each electric vehicle having a battery; and transmit current from the distribution circuitry to the electric vehicle. The current monitor measures the amount of current at each port to estimate the current drawn by each electric vehicle. The computer receives a charging request from each electric vehicle, the charging request from an electric vehicle requesting an amount of power for the battery of the electric vehicle; sets an allocation of power to allocate the maximum output substantially equally among the set of electric vehicles; instructs the distribution circuitry to send current to the electric vehicles according to the allocation of power. The computer adjusts the allocation of power to the electric vehicles by: monitoring, via the current monitor, an actual amount of current drawn by each electric vehicle; determining that the actual amount of current drawn by a particular electric vehicle is less than the amount corresponding to the power allocated to the particular electric vehicle, yielding an available amount of power; adjusting the allocation of power to give the available amount of power to one or more of the other electric vehicles; determining that the adjusted allocation of power provides less than the maximum output to the electric vehicles; readjusting the adjusted allocation of power to allocate the maximum output substantially equally among the electric vehicles; and instructing the distribution circuitry to send the current to the electric vehicles, including the particular electric vehicle, according to the adjusted allocation of power.

### BRIEF DESCRIPTION OF THE DRAWINGS

FIG. 1 illustrates a system that includes an example of a charging system that charges multiple charging targets;

FIG. 2 illustrates an example of a monitor that may be used in the charging system of FIG. 1;

FIG. 3 illustrates an example of a communications system that may be used in the charging system of FIG. 1;

FIG. 4 illustrates an example of a method for charging multiple charging targets that may be used by the charging system of FIG. 1;

FIG. 5 illustrates an example of a method for charging multiple electric vehicles that may be used by the charging system of FIG. 1; and

FIG. 6 illustrates an example of a graphical user interface that a user can use to communicate with the charging system of FIG. 1.

### DESCRIPTION OF EXAMPLE EMBODIMENTS

Referring now to the description and drawings, example embodiments of the disclosed apparatuses, systems, and methods are shown in detail. The description and drawings are not intended to be exhaustive or otherwise limit the claims to the specific embodiments shown in the drawings and disclosed in the description. Although the drawings represent possible embodiments, the drawings are not necessarily to scale and certain features may be simplified, exaggerated, removed, or partially sectioned to better illustrate the embodiments.

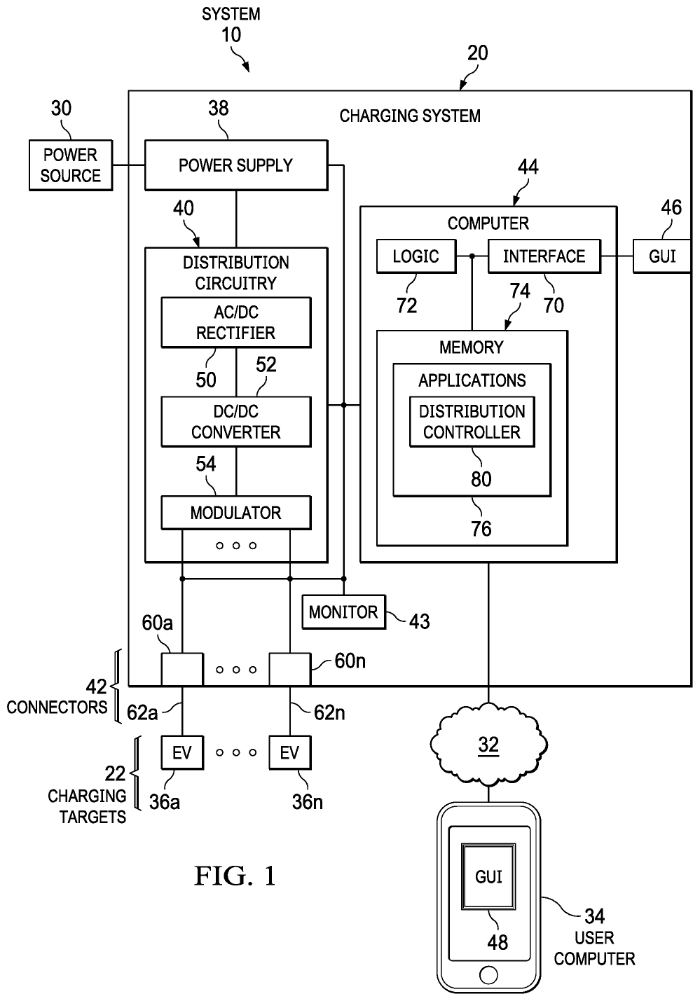

FIG. 1 illustrates a system 10 that includes an example of a charging system 20 that charges multiple charging targets 22. Charging system 20 sends current to multiple charging targets 22 according to an allocation of power. In response to detecting change in a current drawn by a charging target 22, charging system 20 adjusts the allocation of power.

In the illustrated example, system 10 includes a power source 30, charging system 20, charging targets 22, communication network 32, and user computer 34, coupled as shown. Charging system 20 includes a power supply 38, distribution circuitry 40, connectors 42, a current monitor 43, a computer 44, and a graphical user interface (GUI) 46, coupled as shown. Charging targets 22 include electric vehicles (EVs) 36 (36a to 36n). User computer 34 has a GUI 48.

As an overview, power source 30 provides power to charging system 20. Power supply 38 receives current from power source 30, and distribution circuitry 40 distributes the current to connectors 42, according to instructions from computer 44, to send to charging targets 22. Current monitor 43 monitors the current drawn by each charging target 22, and computer 44 may adjust the distribution of current in response to changes in the monitored current. A user can communicate with charging system 20 using GUI 46. Alternatively or additionally, a user can communicate with charging system 20 using GUI 48 of user computer 34, which communicates with charging system 20 via communication network 32.

In the illustrated example, distribution circuitry includes an AC/DC rectifier 50, a DC/DC converter 52, and a modulator 54, coupled as shown. AC/DC rectifier 50 is an electrical device that converts alternating current (AC) to direct current (DC). DC/DC converter 52 is an electrical device that converts DC current from AC/DC rectifier 50 from one voltage level to another. Modulator 54 distributes current from DC/DC converter 52 to connectors 42 according to instructions from computer 44.

Connectors 42 couple charging system 20 to charging targets 22 in order to send current from distribution circuitry 40 to charging targets 22. In the illustrated example, connectors 42 include ports 60 (60a to 60n) and optionally cables 62 62a to 62n). Ports 60 transmit current from distribution circuitry 40 to charging targets 22, and may transmit the current via additional conduits, e.g., cables 62. Current monitor 43 monitors the amount of current drawn by charging targets 22. In general, as charging targets 22 increase in charge, the amount of current they draw decreases.

Computer 44 includes an interface 70, logic 72, memory 74, and applications 76 coupled as shown. Interface 70, logic 72, memory 74, and applications 76 are described in more detail below. Applications 76 include a distribution controller 80 that can instruct distribution circuitry 40 to send current to charging targets 22 according to an allocation of power that specifies an amount of power to be allocated to each charging target 22. The power may describe the charging speed or rate and may be expressed in kilowatts (kW). Distribution controller 80 can also adjust the allocation of power by monitoring, via current monitor 43, an actual amount of current drawn by each charging target 22 and detecting a change in the actual amount of current drawn by a particular charging target 22. Distribution controller 80 can adjust the allocation of power to EVs 36 in response to the change and instruct distribution circuitry 40 to send the current to charging targets 22, including the particular charging target 22, according to the adjusted allocation of power. GUIs 46, 48 allows a user to communicate with charging system 20. More detailed descriptions of examples of the parts of system 10 are provided below.

Power Source. Power source 30 provides source power in the form of an electric current. Examples of a power source 30 include an electric power grid, energy storage devices (e.g., a battery or fuel cell), a generator, a solar power converter, or other similar source that delivers electric current.

Charging Target: Batteries. Charging target 22 is any suitable device that has an electrical energy storage system that can be charged. Examples of such systems include a battery or capacitor. A battery typically has one or more electrochemical cells that store electric charge and generate direct current (DC) through the conversion of chemical energy into electrical energy. A battery is charged by feeding an electric current through the battery such that the cells hold on to the energy passing through them. Examples of batteries include batteries that utilize: lithium ion (e.g., lithium iron phosphate, lithium cobalt oxide or other lithium metal oxides, lithium ion polymer), nickel oxide hydroxide (e.g., nickel metal hydride, nickel cadmium), nickel hydrogen, nickel zinc, silver zinc, or other suitable materials.

Charging Target: Battery Information. A battery has associated battery information that describe the specifications and/or charging information of the battery. Battery information may be communicated to charging system 20 and/or a user before, during, and/or after charging. As an example, battery information may include specifications that, e.g., describe the capabilities of a battery, e.g., battery capacity (the maximum amount of energy a battery can store, typically measured in Watt-hours (Wh)) or energy capacity (amount of energy charge that allows a particular amount of current to flow for a particular amount of time, typically measured in Amp-hours for a C-rate discharge current). Different types of batteries have different battery capacities. A phone battery may have a capacity between 1 to 10 Watt-hours (Wh), a lawn tool battery may have a capacity between 1 to 10 kWh, and an EV battery may have a capacity between 10 kWh to 150 kWh. As technology develops, EV batteries may reach capacities over 150 kWh.

As another example, battery information may include charging information that describes the present conditions of a battery and/or requirements for charging a battery. Examples that describe the condition of a battery include the state of charge, age, or temperature of the battery. The state of charge describes the charge level of the battery, or the present amount of energy in the battery, relative to the maximum energy capacity, and may be expressed as a percentage, where 0% represents empty, and 100% represents full.

These conditions may affect the charging of the battery. In some instances, the charging of a battery slows down as the charge level increases. Charging the final 20% of a nearly full battery may take longer than the first 20% of an empty one, as it becomes increasingly difficult to put energy into the battery cells. In some instances, a battery charges more slowly when colder than when warmer.

Requirements for charging may describe parameters required or recommended for delivering or ceasing delivery of charge. Examples of parameters for delivering charge include the power, voltage, or current at which charging should be delivered. In some cases, the parameters may set a maximum value that should not be exceeded when delivering charge. Examples of parameters for ceasing delivery include a charge limit at which delivery of charging should be ceased.

The parameters may match a specification of the battery or may be a percentage (which may be set by a user) of the specification. As an example, the charging current may be a percentage of the Ah rating of battery, where the percentage could be in the range of 0-5%, 5-10%, 10-15% and/or 15-20%, such as 10%. As another example, the charge limit may be the battery capacity or a percentage of battery capacity, where the percentage could be in the range of 70-80%, 80-90%, 90-95%, and/or 95-100%, such as 95%. In some cases, a user may want to charge a battery for less than the battery capacity. For example, charging the final 20% may take longer, so the user may only charge up to 80% rather than wait for the battery to fill up completely.

Charging Target: Priorities. Priorities may be assigned to charging targets 22 by a user or may be calculated from information provided by the user via, e.g., GUI 46, 48. To simplify the description, let Priority EVi represents the priority of EV 36i, and Priority EVa>Priority EVb represents the priority of EVa is greater or higher than that of EVb.

As an example of user-specified priorities, a user can specify Priority EVa>Priority EVb. The priorities may be relative to another parameter, such as time period or cost. For example, Priority EVa>Priority EVb during daytime hours, and Priority EVa<Priority EVb during nighttime hours. Or, Priority EVa>Priority EVb during the weekdays, and Priority EVa<Priority EVb during the weekend. As another example, Priority EVa>Priority EVb when charging is more expensive, and Priority EVa<Priority EVb when charging is less expensive. As an example of calculated priorities, a user may specify, e.g., that one EV 36a should be charged before another EV 36b. Computer 44 may then determine that Priority EVa>Priority EVb.

Charging Target: Charging Request. In certain examples, charging target 22 sends a charging request to charging system 20 to request power for the battery of the charging target 22. The charging request may include a requested amount power and battery information, such as charging information that describes the present conditions of the battery and/or requirements for charging the battery.

Charging Target: Examples. Examples of types of charging targets 22 include electric vehicles (EV) 36, mobile devices (e.g., cellular telephones, smartphones, tablet computers), cameras (e.g., still photo cameras, video cameras), entertainment systems (e.g., televisions, stereos), home appliances (e.g., kitchen appliances, grooming appliances), personal computers (e.g., laptops, notebooks, tablets), toys and games, and cordless tools (e.g., hardware tools, lawn and garden tools).

In certain embodiments, charging system 20 charges one type of charging target 22, e.g., cordless tools. In other embodiments, charging system 20 charges different types of charging targets 22. For example, charging system 20 may be set to charge one type, and then set to charge another type. As another example, charging system 20 may charge different types of charging targets 22 at the same time.

Charging Target: Electric Vehicle. Electric vehicle 36 is a vehicle that uses one or more electric motors for propulsion. A vehicle is a machine that transports something, e.g., people or cargo. Examples of vehicles include vehicles that transport over land (e.g., car, motorcycle, bus, van, train), over or through water (e.g., boat, submarine), through air or space (e.g., plane, spacecraft). Examples of EVs 36 include: an all-electric vehicle, a hybrid vehicle (HEV), or a low-emission vehicle (LEV).

Communication Network. Communication network 32 enables computers to communicate with each other, e.g., allows computer 44 of charging system 20 to communicate with user computer 34. Examples of a communication network 32 includes the Internet, a wide area network, a metropolitan area network, a local area network, and a personal area network (which may include a smart home hub).

User & User Computer. User computer 34 is a computer that allows a user to communicate with (e.g., send input to and/or receive output from) computer 44 of charging system 20 via GUI 48. Examples of user computer 34 include a mobile device or a personal computer. A user can be a person or computer that communicates with charging system 20. Examples of user include: an owner or operator of charging system 20 or charging target 22, a manufacturer making charging system 20, a technician servicing charging system 20, a computer with artificial intelligence, or other person or computer that communicates with charging system 20.

Charging System. As described above, power supply 38 receives current from power source 30, and distribution circuitry 40 distributes the current to connectors 42, according to instructions from computer 44, to send to charging targets 22. Current monitor 43 monitors the current drawn by each charging target 22, and computer 44 may adjust the allocation of power in response to changes in the monitored current.

Charging System: Charging System Information. Charging system information describes the charging capabilities of charging system 20. This information may be communicated to a charging target 22 and/or a user before, during, and/or after charging. Charging system information may include the maximum output of charging system 20. The maximum output is the maximum power that can be delivered to the charging targets 22. Examples of maximum outputs may be an output selected from one or more of the following ranges of 1-5 kilowatts (kW), 5-40 kW, 40-100 kW, 100-200 kW, and/or 200-400 kW. Charging systems 22 with even higher maximum output (e.g., greater than 400 kW) are contemplated.

In certain cases, the maximum output corresponds to the power delivered to distribution circuitry 40 from power supply 38. In certain cases, the maximum output may be adjusted by a user. The user may set the maximum output for different times of the day, week, month, year, etc. Other examples of charging system 20 information include delivery voltage and delivery current, the voltage and current, respectively, at which charging system 20 delivers charge.

Charging System: Power Supply. In the illustrated example, power supply 38 is a component that receives current from power source 30 and supplies the current to the rest of charging system 20, e.g., to distribution circuitry 40. Power supply 38 may also convert the current from power source 30 to the appropriate voltage, current, and/or frequency.

Charging System: Distribution Circuitry. Distribution circuitry 40 distributes current to connectors 42, according to instructions from computer 44. The instructions include a distribution of current that satisfies an allocation of power, which specifies the amount of power to be allocated to each charging target 22. Distribution circuitry 40 comprises circuitry, e.g., electrical components and conductive material through which electrical current can flow to perform functions. Examples of circuitry include: electrical components connected with wire or traces, a printed circuit board (PCB), an integrated circuit, or similar arrangement of components and conductive material.

In the illustrated example, distribution circuitry 40 includes an AC/DC rectifier 50, a DC/DC converter 52, and a modulator 54, coupled as shown. AC/DC rectifier 50 rectifier is an electrical device that converts alternating current (AC) to direct current (DC). DC/DC converter 52 is an electrical device that converts DC current from AC/DC rectifier 50 from one voltage level to another.

Modulator 54 distributes current from DC/DC converter 52 to connectors 42 according to instructions from computer 44. In certain embodiments, modulator may operate according to pulse width modulation (PWM), or pulse-duration modulation (PDM). A PWM modulator controls the average power delivered by a current by dividing it into discrete parts. In certain embodiments, the average value of voltage (and current) fed to a load can be controlled by turning a power supply switch between a supply and load on and off at a fast rate. The longer the on periods compared to the off periods, the higher the total power supplied to the load.

A PWM modulator can distribute current to multiple loads by turning the switch between the supply and loads at a fast rate. The longer the on periods for a load compared to the on periods for the other loads, the higher the total power supplied to the load. The switch may operate at any suitable frequency, e.g., a frequency in the range of 120 to 500 Hz, 0.5 to 0.9 kHz, 0.9 to 1.5 kHz, 1.5 to 5 kHz, and/or 5 to 10 kHz, e.g., approximately 1 kHz.

Instructions from computer 44 may have any suitable form. In certain embodiments, computer 44 may determine a PWM signal from an allocation of power and provide the PWM signal to modulator 54. In other embodiments, computer 44 may send the allocation of power to modulator 54, and modulator 54 determines the PWM signal from the allocation of power.

Charging System: Power Connectors. A power connector 42 couples distribution circuitry 40 to charging target 22 and transmits current from distribution circuitry 40 to charging target 22. Power connector 42 is a conductor with an insulated material that allows current to flow through it. Examples of power connector 42 include an electrical conductor, cable, cord, or other suitable conductor that can transmit a current from distribution circuitry 40 to charging target 22. In the illustrated example, connectors 42 include ports 60 (60a to 60n) and optionally cables 62 62a to 62n). Ports 60 transmit current from distribution circuitry 40 to charging targets 22, and may transmit the current via additional conduits, e.g., cables 62. Cables 62 may be detachable, which may allow more or different charging targets 22 to be connected to charging system 20. In certain embodiments, cables 62 may not be part of charging system 20, but may be part of EV 36.

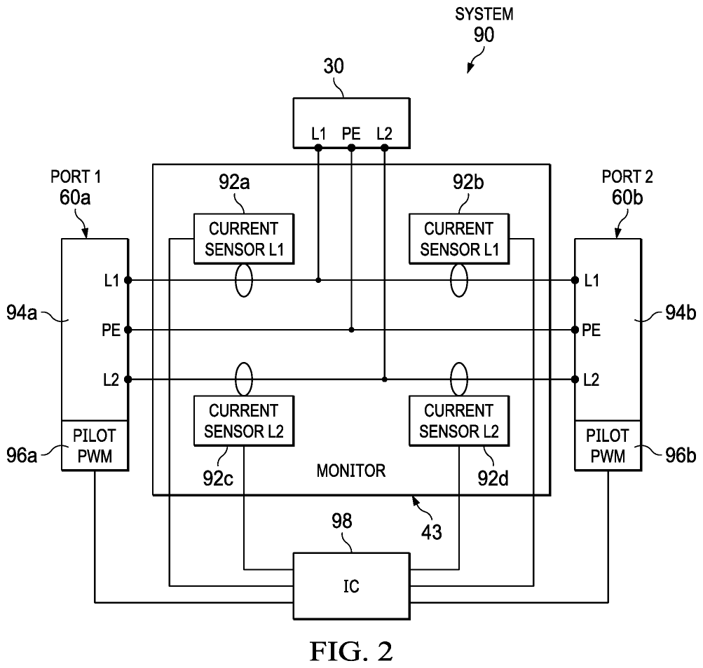

Charging System: Monitor. Monitor 43 monitors the charging of each EV 36 to detect if any EV 36 has available power that may be allocated to another EV 36, and provides that information to computer 44. In certain embodiments, monitor 43 is a current monitor that monitors an actual amount of current drawn by a charging target 22. As a battery charges, the current drawn by the battery decreases, indicating available power. In other embodiments, monitor 43 may monitor the voltage or state of charge of the battery. An example of monitor 43 is described in more detail with reference to FIG. 2.

Charging System: Computer. Computer 44 includes an interface 70, logic 72, and memory 74, which are described in more detail in the “General Computer Information” section below. Computer 44 may include communications logic that facilitates communication with other components of system 10, e.g., charging targets 22, communication network 32, and/or user computer 34 through any suitable physical or wireless communication link. For example, the communications logic may communicate with charging target 22 via power connector 42 (port 60 and/or cable 62) or other wired or wireless connection. As another example, the communications logic may communicate with user computer 34 through a port (not shown) or other wired or wireless connection.

Charging System: Computer: Distribution Controller. Applications 76 include instructions that can be carried out by logic 72 to perform the operations of computer 44. In the illustrated example, applications 76 include a distribution controller 80 that can instruct distribution circuitry 40 to provide power to charging targets 22 according to an allocation of power that specifies an amount of power to be allocated to each charging target 22.

In certain embodiments, computer 44 receives a charging request from each charging target 22. Each charging request requests an amount of power for the battery of the charging target 22. In response to the charging requests, computer 44 instructs distribution circuitry 40 to provide power to charging targets 22 according to an initial allocation of power, which specifies an amount of power to be allocated to each charging target 22. Computer 44 may adjust the allocation of power by: monitoring (via current monitor 43) an actual amount of current drawn by each charging target 22; detecting a change in the actual amount of current drawn by a particular charging target 22; adjust the allocation of power in response to the change; and instruct distribution circuitry 40 to provide the power to charging targets 22, including the particular charging target 22, according to the adjusted allocation of power.

FIG. 2 illustrates a system 90 that includes an example of a monitor 43 that may be used in charging system 20. System 90 includes power source 30, ports 60, monitor 43, and integrated circuit (IC) 98, coupled as shown. Monitor 43 includes current sensors 92 (92a-d), coupled as shown. Ports 60 include Port 1 60a and Port 2 60b. Each port 60 (60a, 60a) includes a set of pins 94 (94a, 94b) and a control pilot connection 96 (96a, 96b), coupled as shown.

In the illustrated example, a port 60 may be an SAE J1772 J Plug port. Set of pins 94 may include pins for AC lines L1 and L2 and a grounding line PE. Control pilot connection 96 may be used to communicate charging information between charging target 22 and charging system 20. In some cases, charging system 20 may use a wave signal to describe the maximum current that is available via the charging system 20 using pulse width modulation. The signal may set current consumption limits for each port. Current sensors 92 measure actual current consumption on lines L1 and L2 of each port. IC 98 may be part of computer 44 and may communicate with control pilot connection 96 and monitor 43 to perform the operations of distribution controller 80. IC 98 may be any suitable integrated circuit that can perform the operations of controller 80, e.g., a STM32 32-bit microcontroller integrated circuit.

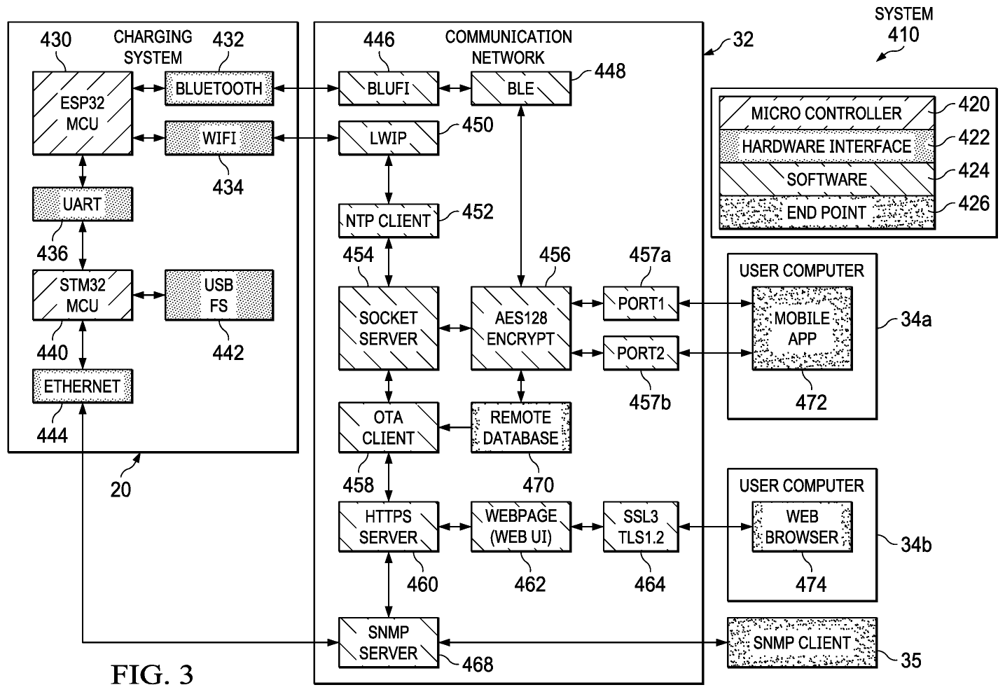

FIG. 3 illustrates an example of a communications system 410 that may be used by system 10 of FIG. 1. System 410 includes micro controllers 420, hardware interfaces (HW IFs) 422, software 424, and endpoints 426 in communication as shown. Charging system 20 communicates with endpoints 426 (SNMP client 35 and user computers 34 (34a, 34b)) via communication network 32.

In the illustrated example, charging system 20 comprises micro controller (e.g., ESP MCU) 430 and micro controller (e.g., STM32 MCU) 440. Micro controller 430 allows for communication via Bluetooth and WIFI, and comprises Bluetooth HW IF 432 and WIFI HW IF 334. Micro controller 440 allows for J1772 and Ethernet connections, and comprises a USB FS HW IF 442 and an Ethernet HW IF 444. USB FS HW IF 442 may be used for initial programming of the MCU. Ethernet HW IF 444 is used by the SNMP server of communication network 32. Micro controller 430 and micro controller 440 have UART HW IFs 436 to communicate with each other.

In the illustrated example, communication network 32 includes the following software 424 and a database (Remote DB) 470. Software 424 of communication network 32 includes: BLUFI 446, software protocol for Bluetooth pairing and requesting WIFI credentials; BLE 448, Bluetooth low energy mode software with a MQTT software server and AES128 encryption; LWIP 450, a light weight TCP/IP low level stack used by TCP/IP services in ESP32; NTP client 452, a network time client that can get current date and time from NTP server via WIFI; socket server 454, an asynchronous nonblocking socket server for communication with an application (e.g., APP) of user computer 34a and with database 470; AES 128 encryption 456, a data encryption using master key and random seed flow for BLE and WIFI data; port (PORT 1) 457a and port (PORT 2) 457b, independent socket connections for data streaming to an application of user computer 34a; OTA client 458, OTA firmware from an OTA server (may be located on database 470); HTTPS server 460, a SSL3 HTTPS server for a web user interface, which is accessible from a web browser of user computer 34b; a webpage 462; encryption protocols (SSL3/TLS 1.2) 464; and SNMP server 468, an SNMP server with a private MIB2 implementation to communicate with SNMP client 35. Database 470 may be a server that provides profile backup and data forwarding to an application of user computer 34a and OTA client 458.

In the illustrated example, user computer 34a has a mobile application 472, which may be a smartphone application for devices that utilize, e.g., Android OS and IOS. User computer 34b has a web browser 474 to access webpage 462.

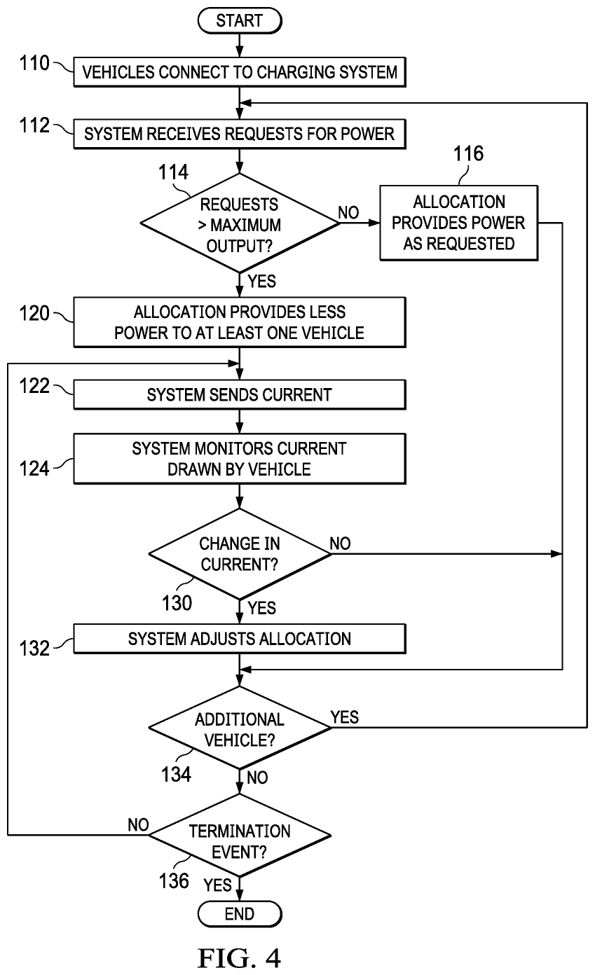

FIG. 4 illustrates an example of a method for charging multiple charging targets 22 that may be used by charging system 20. In the example, charging targets 22 are electric vehicles (EVs) 36 (36a to 36n).

The method starts at step 110, where EVs 36 connect to charging system 20. In certain examples, charging system 20 and EVs 36 exchange charging system information and battery information before, during, and/or after charging. Charging system 20 receive charging requests from EVs 36 at step 112. Each charging request requests an amount of power for the battery of charging target 22. In response to the charging requests, computer 44 determines an initial allocation of power, which specifies an amount of power to be allocated to each charging target 22.

Initial Allocation of Power. To determine the initial allocation of power, computer 44 determines at step 114 whether the requested powers of the charging requests exceed the maximum output, e.g., determines whether the sum of the requested amounts of power is less than or greater than the maximum output. If the sum does not exceed the maximum output, then the method proceeds to step 116, where computer 44 generates an initial allocation that allocates power to EVs 36 to satisfy the requested amounts of power, and distribution circuitry 40 sends current to charging targets 22 according to the allocation. The method then proceeds to step 134.

If the sum exceeds the maximum output at step 114, then the method proceeds to step 120, where computer 44 generates an initial allocation of power that allocates power such that at least one EV 36 receives less power than was requested in its charging request.

Any suitable initial allocation of power may be used. In certain embodiments, power may be allocated using the requested amounts of power. As an example, the allocation may allocate power to the EV 36 with the lowest requested amount of power; and repeat the following from a lower amount of requested power to the next higher amount of requested power until the maximum output is distributed: if there is remaining power, allocate the remaining power to the EV 36 with the next higher requested amount of power. For example, three EVs 36 (36a, 36b, 36c) are connected to charging system 20 with a maximum output of 14 units. (To simplify the description, “unit” represents a generic unit of charging power.) EV 36a requests 5 units of power, EV 36b requests 7 units, and EV 36c requests 9 units. During the initial allocation, EV 36a receives 5 units, EV 36b receives 7 units, but EV 36c receives only 2 units.

As another example, the allocation may allocate more power to an EV 36 with a higher requested amount of power than to an EV 36 with a lower requested amount of power. In some cases, the allocation may allocate more power to an EV 36 with a lower requested amount of power than to an EV 36 with a higher requested amount of power.

As yet another example, the allocation may allocate the power to EVs 36 according to their proportion of their requested power. For example, charging system 20 has a maximum output of 14 units, EV 36a requests 5 units of power, EV 36b requests 7 units, and EV 36c requests 9 units. The total of the requested power is 21 units. The proportion of each EV 36's requested power is the ratio of the requested power and the total requested power, so EV 36a's proportion is 5/21, EV 36b's proportion is 7/21, and EV 36c's proportion is 9/21. During the initial allocation, EV 36a receives 14×5/21 units, EV 36b receives 14×7/21 units, and EV 36c receives 14×9/21 units.

In certain embodiments, the allocation of power may allocate power according to the state of charge of the batteries (the present amount of energy relative to the maximum capacity) of the EVs 36 (which may be determined from charging information from EVs 36). As an example, the allocation may allocate more power to an EV 36 with a higher state of charge than to an EV 36 with a lower state of charge. As another example, the allocation may allocate more power to an EV 36 with a lower state of charge than to an EV 36 with a higher state of charge.

In certain embodiments, computer 44 may determine a priority assigned to each of the EVs 36, and the allocation of power may allocate power according to the priorities. For example, the allocation may allocate power more power to an EV 36 with a higher priority than to an EV with a lower priority. As another example, the allocation may allocate power to the EV 36 with the highest priority; and repeating the following from a higher priority to the next lower priority until the maximum output is distributed: if there is remaining power, allocating power to the EV 36 with the next lower priority. Other suitable allocations may be used, e.g., an allocation of power may allocate the power substantially equally among EVs 36.

Computer 44 instructs distribution circuitry 40 to provide the power to charging targets 22 at step 122 according to the initial allocation of power.

Determining Whether to Adjust the Allocation. Computer 44 determines whether to adjust the allocation of power in response to specified events. In the illustrated embodiment, computer 44 determines whether to adjust the allocation in response to changes in the current drawn by EVs 36. Computer 44 monitors (via current monitor 43) an actual amount of current drawn by EV 36 at step 124.

At step 130, computer 44 may detect (via current monitor 43) a change in the actual amount of current drawn by a particular EV 36. The change may indicate that the actual amount of current drawn by the particular EV 36 has decreased to yield an available amount of power. If a change is detected, the method proceeds to step 132, where computer 44 adjusts the allocation of power in response to the change. Computer 44 identifies a set of one or more of the other EVs 36 that are receiving less than their requested power, and adjusts the allocation to allocate the available amount to the identified set of EVs 36. If the particular EV 36 (that is drawing less current) is not fully charged, the allocation still allocates power to the EV 36 until it is fully charged. Thus, charger system 20 differs from a charger that merely switches power from a fully charged battery to another battery. If the no change is detected, the method proceeds to step 134.

In other embodiments, computer 44 may determine whether to adjust the allocation in response to battery information from EV 36. For example, an EV 36 may inform charging system 20 of a condition of the battery that affects the charging, such as the state of charge of the battery. In response, computer 44 determines whether to adjust the allocation.

Adjusted Allocation of Power. The allocation of power may be adjusted to distribute the available amount of power according to any suitable procedure. Some procedures may be similar to procedures described previously with reference to the initial allocation of power. As an example, the allocation may allocate the available amount substantially equally among the set of other EVs 36.

In certain embodiments, the allocation of power may allocate the available amount using the requested powers of the EVs 36 of the set. For example, the allocation may: (1) allocate the available amount according to their proportion of their requested power; (2) allocate more of the available amount to an EV 36 with a lower requested power than to an EV 36 with a higher requested power; (3) allocate more of the available amount to an EV 36 with a higher requested power than to an EV 36 with a lower requested power; (4) allocate the available amount the EV 36 with the lowest requested power; and/or (5) allocate the available amount the EV 36 with the highest requested power.

In certain embodiments, the allocation of power may allocate the available amount according to the state of charge of the batteries of the EVs 36 of the set (which may be determined from charging information sent from EVs 36). For example, the allocation may: (1) allocate more of the available amount to an EV 36 with a higher state of charge than to an EV 36 with a lower state of charge; (2) allocate more of the available amount to an EV 36 with a lower state of charge than to an EV 36 with a higher state of charge; (3) allocate the available amount to the EV 36 with the highest state of charge; and/or (4) allocate the available amount to the EV 36 with the lowest state of charge.

In certain embodiments, computer 44 may determine a priority assigned to each of EVs 36 of the set, and define the allocation of power according to the priorities. For example, the allocation may allocate more of the available power to an EV 36 with a higher priority than to an EV 36 with a lower priority. As another example, the allocation may allocate at least some of the available amount to the electric vehicle with the highest priority to reach the requested amount of power for the electric vehicle; and repeat the following from a higher priority to the next lower priority until the available amount is distributed or until the requested amounts of power for the EVs 36 have been satisfied: if there is remaining power, allocating the remaining power to the EV 36 with the next lower priority to reach the requested amount of power for the EV 36. After adjusting the allocation, the method proceeds to step 134.

Additional Vehicle. There may be an additional EV 36 that connects to charging system 20 at step 134. If there is an additional EV 36, the method returns to step 112, where system 20 receives a charging request from the additional EV 36. If there is no additional EV 36, the method proceeds to step 136.

Termination Event. Charging system 20 distributes current to EVs 36 until there is a termination event. There may be a termination event at step 136. Examples of termination event include: all EVs 36 have received their requested amount of power, all EVs 36 have received the amount of power allocated to them by charging system 20, all EVs 36 have been disconnected from charging system 20, or a user-set time is reached. If there is no termination event, the method returns to step 122, where system 20 continues to send current. If there is a termination event, the method ends.

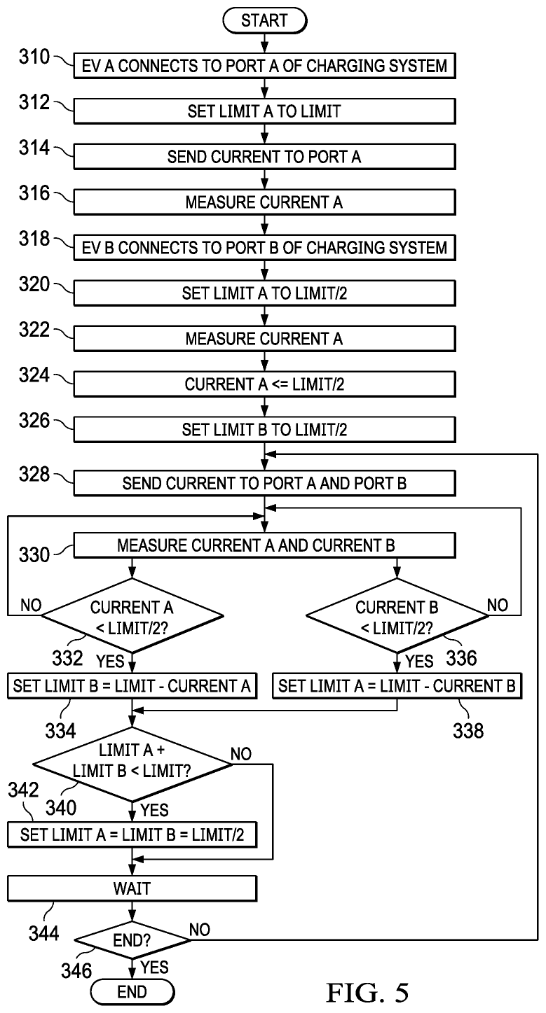

FIG. 5 illustrates an example of a method for charging electric vehicles EVs 36, e.g., EV A and EV B, that may be used by charging system 20 with ports 60, e.g., Port A and Port B. In the example, charging system 20 has a current limit Limit, which is the maximum total current that system 20 supplies to ports 60, which may be related to the maximum power output of system 20. Charging system 20 limits the amount of current sent to each port 60. Limit A represents the limit of current sent to Port A, and Limit B represents the limit of current sent to Port B. Charging system 20 also measures the amount of current drawn at each port 60. Current A represents the amount of current drawn at Port A, and Current B represents the amount of current drawn at Port B.

The method starts at step 310, where EV A connects to Port A of charging system 20. EV A is the only EV connected to charging system 20, so charging system 20 sets Limit A to Limit at step 312. Charging system 20 sends current to Port A at step 314. Charging system 20 measures Current A at step 316.

EV B connects to Port B of charging system 20 at step 318. In response, charging system 20 sets Limit A to a fraction lip of Limit. Fraction 1/p may be any suitable fraction, e.g., a fraction in the range of ¼ to ½ or ½ to ¾. In the illustrated example, fraction lip is ½, so Limit A is set to Limit/2 at step 320. Charging system 20 measures Current A at step 322. Current A is less than or equal to Limit A, i.e., lip of Limit=Limit/2 at step 324. Charging system 20 sets Limit B to a fraction 1/q of Limit, where 1/q=1-1/p=½, i.e., Limit B is set to Limit/2.

Charging system 20 sends current to Port A and Port B at step 328, and measures Current A and Current B at step 330. At steps 332 to 336, an EV may be drawing less current than had been allocated to the EV, yielding an available amount of current, so charging system 20 allocates the available amount to the other EV.

Specifically, Current A may be less than Limit/2 at step 332. If Current A is not less than Limit/2, the method returns to step 330, where charging system 20 continues to measure Current A. If Current A is less than Limit/2, this indicates there is current available for Port B, so the method proceeds to step 334, where charging system 20 sets Limit B to Limit minus Current A. The method then moves to step 340.

Current B may be less than Limit/2 at step 336. If Current B is not less than Limit/2, the method returns to step 330 to continue to measure Current B. If Current B is less than Limit/2, this indicates there is current available for Port A, so the method proceeds to step 338, where charging system 20 sets Limit A to Limit minus Current B. The method then moves to step 340.

The sum of Limit A and Limit B may be less than Limit at step 340. If the sum is less than Limit, the method proceeds to step 342, where charging system 20 sets Limit A=Limit B=Limit/2, and then the method proceeds to step 344. If the sum is not less than Limit, the method proceeds directly to step 344. Charging system waits at step 344. Charging system may wait for any suitable period, e.g., a period selected from a range of 1 to 60, 60 to 100, 100 to 200, 200 to 300, and/or 300 to 500 seconds, such as in a range of 60 to 300 seconds. The method may end at step 346, e.g., in response to a termination event. If the method does not end at step 346, the method returns to step 328, where charging system 20 continues to send current to Port A and Port B. Otherwise, the method ends.

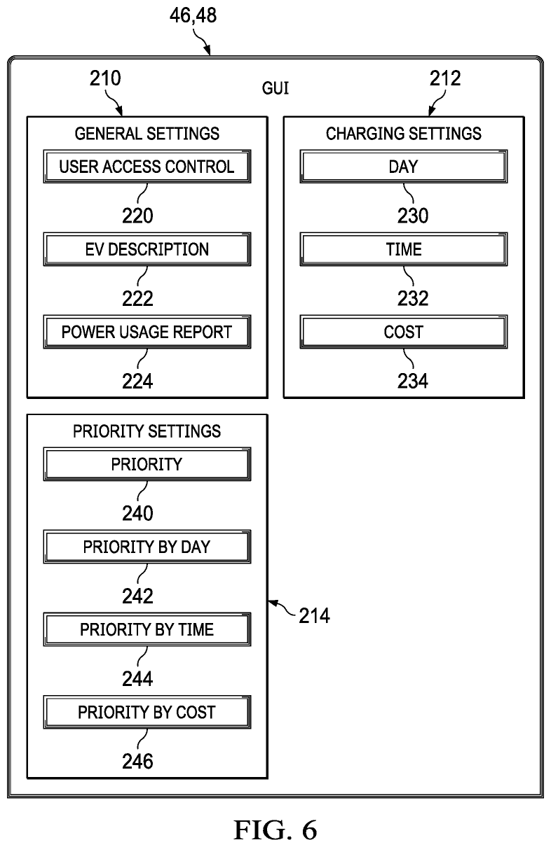

FIG. 6 illustrates an example of a GUI 46, 48 that a user can use to communicate with charging system 20. GUI 46, 48 may include any suitable graphical elements that a user may interact with to communicate with charging system 20. Examples of graphical elements include a cursor that can be moved, a box that can be selected to choose an option, a button that can be selected to perform an action, and a field into which input can be placed. In other embodiments, a user may use any suitable interface to interact with charging system 20.

The illustrated example includes sections for general settings 210, charging settings 212, and priority settings 214. General settings 210 may be used to specify general operations of charging system 20. In the illustrated example, general settings 210 include buttons for user access control 220, EV description 222, and power usage report 224. User access control 220 may be used to provide information about users allowed to access computer 44 of charging system 20. EV description 222 may be used to provide information about EVs 36 allowed to be charged by charging system 20. Power usage report 224 may be used to generate a report of power used to charge charging targets 22.

Charging settings 212 may be used to specify charging operations for charging system 20. In the illustrated example, charging settings 212 include buttons that can be used to set of charging by day 230, time 232, or cost of power 234. Charging by day 230 may be used to specify days of the week, year, or month that charging system 20 can be used. Charging by day 230 may be used to set limits (e.g., the time of day, total charging time, and/or total power used) for specific days. Charging by time 232 may be used to specify the time periods of a day charging system 20 can be used. Limits (e.g., the total charging time and/or total power used) may be set for the time periods. Charging by cost 234 may be used to specify when charging system 20 can be used based on the price of power. For example, charging may be limited when the price of power is higher. Limits (e.g., the total charging time and/or total power used) may be set based on the price of power.

Priority settings 214 may be used to specify priorities among charging targets 22. In the illustrated example, priority settings 214 include buttons that can be used to set a general priority 240 or priority by day 242, time 244, or cost 246. General priority 240 may be used to set a priority for each EV 36, e.g., Priority EVa>Priority EVb. Priority by day 242 may be used to specify different priorities for different days, e.g., Priority EVa>Priority EVb during the weekdays, and Priority EVa<Priority EVb during the weekend. Priority by time 244 may be selected to specify priorities for different times of the day, e.g., Priority EVa>Priority EVb during daytime hours, and Priority EVa<Priority EVb during nighttime hours. Priority by cost 246 may be used to specify priorities based on the cost of power, e.g., Priority EVa>Priority EVb when charging is more expensive, and Priority EVa<Priority EVb when charging is less expensive.

General Computer Information. A component (e.g., computer 44, user computer 34, or distribution circuitry 40) of the systems and apparatuses disclosed herein may include an interface, logic, and/or memory (any of which may include hardware and/or software), coupled as appropriate via, e.g., a bus system. An interface can receive input to the component, send output from the component, and/or process the input and/or output. Logic can perform operations of the component. Logic may include one or more electronic devices that process data, e.g., execute instructions to generate output from input. Examples of such an electronic device include a computer, processor or microprocessor (e.g., a Central Processing Unit (CPU) or micro controller), and computer chip. Logic may include computer software that encodes instructions capable of being executed by the electronic device to perform operations. Examples of computer software includes a computer program, an application, and an operating system.

A memory can store information and may comprise tangible, computer-readable, and/or computer-executable storage medium. Examples of memory include computer memory (e.g., Random Access Memory (RAM) or Read Only Memory (ROM)), mass storage media (e.g., a hard disk), removable storage media (e.g., a Compact Disk (CD) or Digital Video or Versatile Disk (DVD)), database and/or network storage (e.g., a server), and/or other computer-readable media. Particular embodiments may be directed to memory encoded with computer software.

Modifications. Although this disclosure has been described in terms of certain embodiments, modifications (such as changes, substitutions, additions, omissions, and/or other modifications) of the embodiments will be apparent to those skilled in the art. Accordingly, modifications may be made to the embodiments without departing from the scope of the invention. For example, modifications may be made to the systems and apparatuses disclosed herein. The components of the systems and apparatuses may be integrated or separated, or the operations of the systems and apparatuses may be performed by more, fewer, or other components. As another example, modifications may be made to the methods disclosed herein. The methods may include more, fewer, or other steps, and the steps may be performed in any suitable order.

To aid the Patent Office and readers in interpreting the claims, Applicants wish to note that they do not intend any of the claims or claim elements to invoke 35 U.S.C. § 112(f) unless the words “means for” or “step for” are explicitly used in the particular claim. Use of any other term (e.g., “mechanism,” “module,” “device,” “unit,” “component,” “element,” “member,” “apparatus,” “machine,” “system,” “processor,” or “controller”) within a claim is understood by the applicants to refer to structures known to those skilled in the relevant art and is not intended to invoke 35 U.S.C. § 112(f).

What is claimed:

1. A charging system comprising:
a distribution circuitry configured to provide power from a power supply up to a maximum output;
a plurality of power connectors, each power connector configured to:
couple the distribution circuitry to an electric vehicle of a plurality of electric vehicles, each electric vehicle having a battery; and
transmit current from the distribution circuitry to the electric vehicle; and
a computer configured to:
receive a charging request from each electric vehicle, the charging request from an electric vehicle requesting an amount of power for the battery of the electric vehicle;
determine an allocation of power according to the charging requests, the allocation of power specifying an amount of power to be allocated to each electric vehicle;
instruct the distribution circuitry to send current to the electric vehicles according to the allocation of power; and
adjust the allocation of power to the electric vehicles by:
monitoring an actual amount of current drawn by each electric vehicle;
detecting a change in the actual amount of current drawn by a particular electric vehicle;
adjusting the allocation of power to the electric vehicles in response to the change; and
instructing the distribution circuitry to send the current to the electric vehicles, including the particular electric vehicle, according to the adjusted allocation of power.

2. The system of claim 1, the computer configured to determine the allocation of power according to the charging requests by:
determining that the sum of the requested amounts of power of the charging requests is less than the maximum output; and
defining the allocation of power to allocate the requested amounts of power to the electric vehicles.

3. The system of claim 1, the computer configured to determine the allocation of power according to the charging requests by:
determining that the sum of the requested amounts of power of the charging requests is greater than the maximum output; and
defining the allocation of power to allocate to at least one electric vehicle less power than was requested in its charging request.

4. The system of claim 3, the computer configured to define the allocation of power to allocate to at least one electric vehicle less power than was requested by:
allocating power to the electric vehicle with the lowest requested amount of power;
repeating the following from a lower amount of requested power to the next higher amount of requested power until the maximum output is distributed:
if there is remaining power, allocating the remaining power to the electric vehicle with the next higher requested amount of power.

5. The system of claim 3, the computer configured to define the allocation of power to allocate to at least one electric vehicle less power than was requested by:
allocating more power to an electric vehicle with a higher requested amount of power than to an electric vehicle with a lower requested amount of power.

6. The system of claim 3, the computer configured to define the allocation of power to allocate to at least one electric vehicle less power than was requested by:
allocating the power to the electric vehicles according to their proportion of their requested power.

7. The system of claim 3, the computer configured to define the allocation of power to allocate to at least one electric vehicle less power than was requested by:
allocating the power substantially equally among the electric vehicles.

8. The system of claim 3, the computer configured to define the allocation of power to allocate to at least one electric vehicle less power than was requested by:
determining a state of charge for the battery of each electric vehicle; and
allocating power according to the states of charge of the batteries.

9. The system of claim 3, the computer configured to define the allocation of power to allocate to at least one electric vehicle less power than was requested by:
determining a priority assigned to each of the electric vehicles; and
allocating more power to an electric vehicle with a higher priority than to an electric vehicle with a lower priority.

10. The system of claim 3, the computer configured to define the allocation of power to allocate to at least one electric vehicle less power than was requested by:
determining a priority assigned to each of the electric vehicles; and
allocating power to the electric vehicle with the highest priority;
repeating the following from a higher priority to the next lower priority until the maximum output is distributed:
if there is remaining power, allocating the remaining power to the electric vehicle with the next lower priority.

11. The system of claim 1, the computer configured to adjust the allocation of power to the electric vehicles by:
determining that the actual amount of current drawn by the particular electric vehicle has decreased to yield an available amount of power;
identifying a set of one or more of the other electric vehicles that are receiving less than their requested power; and
increasing the power allocated to the set of electric vehicles by the available amount.

12. The system of claim 11, the computer configured to increase the power allocated to the set of electric vehicles by the available amount by:
allocating the available amount substantially equally among the set of electric vehicles.

13. The system of claim 11, the computer configured to increase the power allocated to the set of electric vehicles by the available amount by:
allocating the available amount to the set of electric vehicles according to their proportion of their requested power.

14. The system of claim 11, the computer configured to increase the power allocated to the set of electric vehicles by the available amount by:
allocating more of the available amount to an electric vehicle of the set with a lower requested power than to an electric vehicle of the set with a higher requested power.

15. The system of claim 11, the computer configured to increase the power allocated to the set of electric vehicles by the available amount by:
allocating more of the available amount to an electric vehicle of the set with a higher requested power than to an electric vehicle of the set with a lower requested power.

16. The system of claim 11, the computer configured to increase the power allocated to the set of electric vehicles by the available amount by:
determining a priority assigned to each electric vehicle of the set; and
allocating more of the available amount to an electric vehicle of the set with a higher priority than to an electric vehicle of the set with a lower priority.

17. The system of claim 11, the computer configured to increase the power allocated to the set of electric vehicles by the available amount by:
determining a priority assigned to each electric vehicle of the set; and
allocating at least some of the available amount to the electric vehicle with the highest priority to reach the requested amount of power for the electric vehicle;
repeating the following from a higher priority to the next lower priority until the available amount is distributed or until the requested amounts of power for the set of electric vehicles have been reached:
if there is remaining power, allocating the remaining power to the electric vehicle with the next lower priority to reach the requested amount of power for the electric vehicle.

18. A charging system comprising:
a distribution circuitry configured to provide power from a power supply up to a maximum output;
a plurality of power connectors, each power connector configured to:
couple the distribution circuitry to an electric vehicle of a plurality of electric vehicles, each electric vehicle having a battery; and
transmit current from the distribution circuitry to the electric vehicle; and
a computer configured to:
receive a charging request from each electric vehicle, the charging request from an electric vehicle requesting an amount of power for the battery of the electric vehicle;
set an allocation of power to allocate the maximum output substantially e qually among the set of electric vehicles;
instruct the distribution circuitry to send current to the electric vehicles according to the allocation of power; and
adjust the allocation of power to the electric vehicles by:
monitoring an actual amount of current drawn by each electric vehicle;
determining that the actual amount of current drawn by a particular electric vehicle is less than the amount corresponding to the power allocated to the particular electric vehicle, yielding an available amount of power;
adjusting the allocation of power to give the available amount of power to one or more of the other electric vehicles; and
instructing the distribution circuitry to send the current to the electric vehicles, including the particular electric vehicle, according to the adjusted allocation of power.

19. The system of claim 18, the computer configured to adjust the allocation of power to the electric vehicles by:
determining that the adjusted allocation of power provides less than the maximum output to the electric vehicles; and
setting the adjusted allocation of power to allocate the maximum output substantially equally among the electric vehicles.

20. A charging system comprising:
a distribution circuitry configured to provide power from a power source up to a maximum output;
a plurality of power connectors, each power connector comprising a port configured to:
couple the distribution circuitry to an electric vehicle of a plurality of electric vehicles, each electric vehicle having a battery; and
transmit current from the distribution circuitry to the electric vehicle;
a current monitor configured to measure the amount of current at each port to estimate the current drawn by each electric vehicle; and
a computer configured to:
receive a charging request from each electric vehicle, the charging request from an electric vehicle requesting an amount of power for the battery of the electric vehicle;
set an allocation of power to allocate the maximum output substantially equally among the set of electric vehicles;
instruct the distribution circuitry to send current to the electric vehicles according to the allocation of power; and
adjust the allocation of power to the electric vehicles by:
monitoring, via the current monitor, an actual amount of current drawn by each electric vehicle;
determining that the actual amount of current drawn by a particular electric vehicle is less than the amount corresponding to the power allocated to the particular electric vehicle, yielding an available amount of power;
adjusting the allocation of power to give the available amount of power to one or more of the other electric vehicles;
determining that the adjusted allocation of power provides less than the maximum output to the electric vehicles;
readjusting the adjusted allocation of power to allocate the maximum output substantially equally among the electric vehicles; and
instructing the distribution circuitry to send the current to the electric vehicles, including the particular electric vehicle, according to the adjusted allocation of power.
